(19) United States
(12) Patent Application Publication
(10) Pub. No.: US 2022/0353435 A1
(43) Pub. Date: Nov. 3, 2022

(54) System, Device, and Method for Enabling High-Quality Object-Aware Zoom-In for Videos

(71) Applicant: CLOUDINARY LTD., Petah Tikva (IL)

(72) Inventors: Amnon Cohen-Tidhar, Zoran (IL); Eran Gonen, Kfar Saba (IL); Tal Lev-Ami, Modiin (IL)

(21) Appl. No.: 17/243,637

(22) Filed: Apr. 29, 2021

(51) Int. Cl. H04N 5/262; H04N 7/01; G06K 9/00; G06T 7/20; G11B 27/10; H04N 5/272

(52) U.S. Cl. CPC H04N 5/2628; H04N 7/0117; G06K 9/00765; G06T 7/20; G11B 27/10; H04N 5/272; G06T 2207/10016

(57) ABSTRACT

System, device, and method for enabling high-quality content-aware zoom-in for videos. An input video is received at high resolution, and is processed. A first video stream is generated, being a downscaled lower-resolution version of the input video. One or more additional video streams are generated; each one of them being a cropped high-resolution version of the input video, such that the cropped region tracks an object-of-interest that is visually depicted in the input video. A multiple-streams manifest is generated, pointing to the first, downscaled, video stream, and also pointing to the one or more other, cropped high-resolution video stream. An end-user device plays the video, and enables the end-user to perform a high-quality zoom-in on the object-of-interest, by transitioning from playback of the downscaled video stream to playback of the additional video stream that tracks that object-of-interest.

### FIELD

Some embodiments are related to the field of video processing and video playback.

### BACKGROUND

Electronic devices and computing devices are utilized on a daily basis by millions of users worldwide. For example, laptop computers, desktop computers, smartphone, tablets, and other electronic devices are utilized for browsing the Internet, consuming digital content, streaming audio and video, sending and receiving electronic mail (email) messages, engaging in Instant Messaging (IM) and video conferences, playing games, or the like.

### SUMMARY

Some embodiments include systems, devices, and methods for enabling high-quality object-aware zoom-in functionality for videos. For example, an input video is received at high resolution, and is processed. A first video stream is generated, being a downscaled lower-resolution version of the input video. One or more additional video streams are generated; each one of them being a non-downscaled yet cropped version of the input video, such that the cropped region tracks an object-of-interest that is visually depicted in the input video. A multiple-streams manifest is generated, pointing to the first, downscaled, video stream, and also pointing to the one or more other, cropped and non-downscaled video stream. An end-user device plays the video, and enables the end-user to perform a high-quality zoom-in on the object-of-interest, with smooth and seamless transitioning from playback of the downscaled video stream to playback of the additional video stream that tracks that object-of-interest.

Some embodiments may provide other and/or additional benefits and/or advantages; for example, enabling continuous and undisturbed playback of a video content on a low resolution display device, or on a device connected to a low bandwidth communication link or network, while also enabling the user of such device to see and observe the fine details as captured in a high quality/high resolution version of that video.

### BRIEF DESCRIPTION OF THE DRAWINGS

FIG. 1 is an illustration of a system, in accordance with some demonstrative embodiments.

FIGS. 2A-2H are illustrations of frames from different versions of a video of a soccer game, as processed and/or produced by a system in accordance with some demonstrative embodiments.

FIGS. 3A-3F are illustrations of frames from various versions of video of fashion show, as processed and/or produced by a system in accordance with some demonstrative embodiments.

### DETAILED DESCRIPTION OF SOME DEMONSTRATIVE EMBODIMENTS

The Applicants have realized that an increasing number of video content is being captured at very high resolution, such as 4K resolution (3,840 by 2,160 pixels) or 8K resolution (7,680 by 4,320 pixels); yet many videos are later consumed or played at a reduced resolution, such as 720p (1,280 by 720 pixels) or 1080p (1,920 by 1,080 pixels) due to physical screen size (e.g., smartphone or tablet), bandwidth limitations, communication network constraints, or other reasons. The Applicants have also realized that changing or adapting video resolution, from the (higher) acquisition resolution to the (lower) display resolution or deliver resolution, is often performed via down-scaling and/or compression algorithms, which allows video delivery over limited bandwidth but also removes or discards the fine content details that were captured in the original high-resolution video.

The Applicants have also realized that some users desire to consume video content in an interactive way or an active way or a non-passive way; such that the viewer is not just passively watching the video, but rather, the viewer has control over the video player, ranging from basic control operations (pause, resume, fast-forward, rewind) to more advanced control operations (increased-speed playback, reduced-speed playback, changing the window size of the video, changing the viewport when watching 360 degrees content, or the like).

Some embodiments provide systems, devices, and methods (as well as a particular format or protocol, and a suitable algorithm) to enable a viewer of a video, who utilizes an electronic device for video playback or video consumption or video engagement, to perform high-quality zoom-in function (and high-quality zoom-out function), on a specific object that is shown in the video content, and/or on a specific area-of-interest or object-of-interest that is depicted in the video content; and to consume or view fine details or finer details of the video content of such particular object-of-interest or area-of-interest during playback or consumption of such video. Some embodiments do not merely increase the size of an on-object; but rather, generate and reveal and display finer details of the content video that was not displayed prior to the zoom-in operation, based on the finer details of the video as captured at the higher resolution; thereby providing a real and meaningful zoom-in functionality while adhering to current constraints of the screen resolution of the electronic device and the available bandwidth.

The Applicants have realized that conventional video management systems operate by serving to the end-user device a lower-resolution version of an original high-resolution video; thereby losing some content details that are not displayed on the end-user device at regular playback or even when the end-user device performs a zoom-in operation, which merely enlarges a portion of the content without adding content details that were already discarded or lost when the lower-resolution version was generated and/or served. For example, a video is produced and uploaded to a video management service or server at a high resolution, such as 4K resolution. The end-user device (e.g., a smartphone) is requesting the video for viewing over a limited bandwidth network and/or on a limited resolution screen or display window. In order to support such video playback request, some conventional video servers perform down-scaling of the original high-resolution video and generate a scaled-down lower-resolution video, which meets the end-user device's constraints of available display resolution and/or available bandwidth, and delivers such lower-resolution version of the video to the end-user device for local playback at such lower resolution; thereby discarding or losing fine video content, which cannot be revealed or retrieved by the end-user device via a zoom-in operation. Alternatively, some conventional video serving systems generate in advance multiple versions or multiple segmented versions of a particular high-resolution video (e.g., producing in advance a 360p version and a 480p version and a 720p version of an original 4K video), and optionally utilize a manifest (e.g., as HTTP Live Streaming (HLS) manifest, or as MPEG Dynamic Adaptive Streaming over HTTP (DASH) manifest) which allows the end-user device to select a specific video version to fit its display size and/or the currently available bandwidth, or to select a specific video segment from that version of the video that fits its display size and/or the currently available bandwidth.

For example, in a demonstrative conventional system, the end-user device may have a window size resolution of 640 by 360 pixels; the original 4K video is down-scaled by a factor of 6, thereby losing or discarding many fine details of the original video content. Similarly, in a demonstrative conventional system, the end-user device may consume video over a communication link having a bandwidth of 1 megabit per second, which is not suitable for 4K video delivery; and the conventional video server may downscale and/or compress the video to accommodate the available bandwidth, thereby losing or discarding many fine details of the original video content. In both of these examples of a conventional system, the end-user device receives and displays a lower-resolution video in which some of the content details of the original high-resolution video are lost or discarded; and a conventional interpolation-based zoom-in operation on the end-user device is unable to reveal or to add such finer visual data that was already discarded or lost.

Some embodiments operate fundamentally differently, in order to generate and serve a lower-resolution video version that accommodates the available bandwidth of the end-user device and/or the available display window size of the end-user device, while also providing a meaningful and useful zoom-in functionality that enables the end-user device to reveal and display finer visual details of the original video content upon a zoom-in command from the end-user during video playback or video consumption or video engagement.

In some embodiments, for example, a high-resolution video (e.g., a 4K video) is uploaded to a server. The server performs content processing of the uploaded high-resolution video, using a computer vision algorithm and/or object recognition algorithm and/or object identification algorithm (e.g., optionally utilizing Machine Learning (ML) or Artificial Intelligence (AI) or image comparison or other suitable methods), and/or optionally takes into account or utilizes manual input provided by a human moderator (e.g., who reviewed the video and indicated the presence and/or location of object(s) to be tracked), and detects or identifies or recognizes particular objects that are depicted in the video content (“objects-of-interest”). An object-of-interest may be, for example, a depiction of a human; a depiction of an animal; a depiction of a particular tangible object or item (e.g., a soccer ball, a toy); a depiction of a wearable item or article-of-clothing or garment or accessory; or the like. The server then produces or generates multiple (two or more) variants or versions of the original high-resolution video, at different bitrates and at different resolutions, by taking into account the detected object(s)-of-interests and its (their) in-frame location(s). In contrast with a conventional system, which merely performs a content-agnostic or object-agnostic down-scaling of the entire video, some embodiments generate or produce one or more cropped versions of the video, that are smaller in size, yet maintains high resolution and visual details of the objects-of-interest and their immediate surrounding, or of recognized areas-of-interest in the visual content of the video. The multiple versions of variants of the original high-resolution video are then described or indicated via a suitable manifest (e.g., HTTP Live Streaming (HLS) manifest, or MPEG Dynamic Adaptive Streaming over HTTP (DASH) manifest), which is downloaded and processed by the end-user device. Such end-user device may thus offer to the viewer to select between, or to switch among, multiple views of the video: (i) a full field-of-view of the video, displayed at the reduced resolution, to meet the available screen resolution and/or the current bandwidth constraint; or (ii) a high-resolution cropped version of the original video, which follows a specific object-of-interest. All the different versions of the original video may be segmented and encoded in synchronization, such that seamless playback can be achieved while the end-user switches between video versions.

In a demonstrative example of an embodiment, a 4K video, which depicts a soccer game, is captured and uploaded to a server. The server performs computer vision analysis of the video which spans 60 seconds, and identifies two objects of interest: (i) the forward player of Team A, who is about to kick a penalty kick; (ii) the goalkeeper of Team B, who is protecting his net. The server produces a first version of the video at 480p resolution (854 by 480 pixels), depicting the entire field-of-view as depicted in the original 4K video. The server also generates a second version of the video, also at 480p resolution; however, the second video includes a segment, from the 15th second through the 24th second of the video, which depicts (at 480p resolution) the forward player and its immediate surrounding, as a cropped (e.g., and non-downscaled) portion from the frames of the original 4K video; thereby allowing the end-user to request, and to view, a high-quality zoomed-in playback of the forward player and its surrounding during a particular time-slot or time-segment of the video in which the forward player is an object-of-interest. The server also generates a third version of the video, also at 480p resolution; however, the third video includes a segment, from the 24th second through the 29th second of the video, which depicts (at 480p resolution) the goalkeeper and its immediate surrounding, as a cropped (e.g., and non-downscaled) portion from the frames of the original 4K video; thereby allowing the end-user to request, and to view, a high-quality zoomed-in playback of the goalkeeper and its surrounding during a particular time-slot or time-segment of the video in which the goalkeeper is an object-of-interest.

In another demonstrative example of an embodiment, a 4K video, which depicts a model walking on a runway in a fashion show, is captured and uploaded to a server. The server performs computer vision analysis of the video which spans 60 seconds, and identifies four objects of interest: (i) the shirt worn by the model; (ii) the skirt worn by the model; (iii) the shoes worn by the model; (iv) an accessory handbag held by the model. The server proceeds to generate five versions from the original high-resolution video; each version at (for example) 720p resolution. One version depicts the entire original field-of-view, downscaled from 4K resolution to 720p resolution. The other four version are also 720p versions, which depict, at least in some of their time segments, a 720p cropped area-of-interest that shows one of these four identified objects and their immediate surrounding; thereby allowing the end-user to request, and to view, a high-quality zoomed-in playback of each garment.

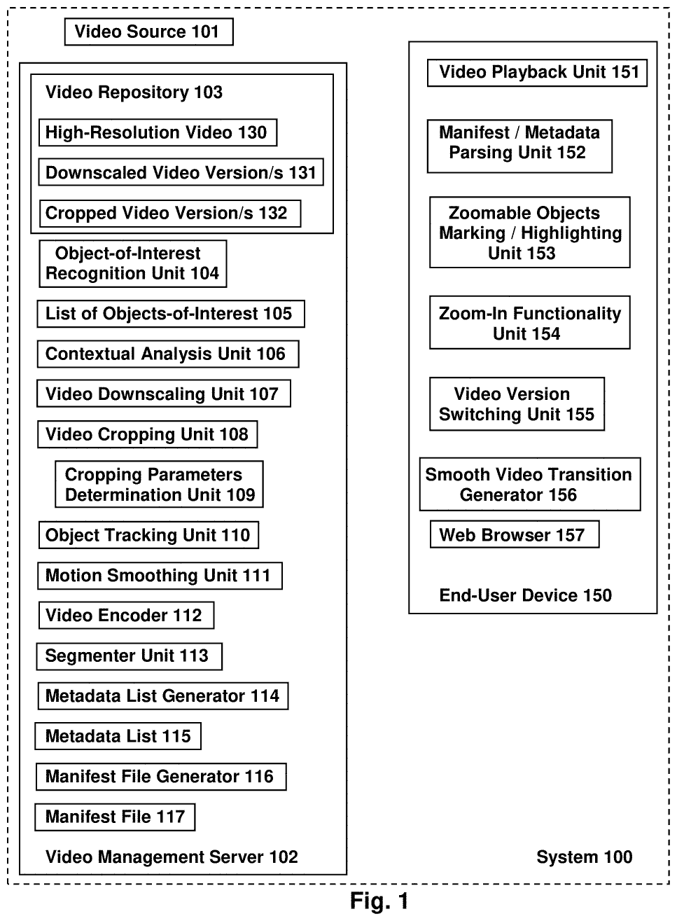

Reference is made to FIG. 1, which is a schematic block-diagram illustration of a system 100, in accordance with some demonstrative embodiments. System 100 may be implemented by using suitable hardware components and/or software components.

A Video Source 101 generates or provides a High-Resolution Video 130 (e.g., an 8K video, or a 4K video, or a 1080p video). The Video Source may be, for example, a video camera, an audio/video acquisition device, an audio/video capturing device, a smartphone, a tablet, an electronic device equipped with a camera and optionally a microphone, a laptop computer or desktop computer equipped with a camera and optionally a microphone, a computing device which receives a video file from a video acquisition device and then stores and/or processes such video (e.g., a video editing workstation), or other video source.

Video Source 101 uploads or sends the high-resolution video to a Video Management Server 102, which in turn stores the high-resolution video (e.g., at least temporarily) in a Video Repository 103.

An Object-of-Interest Recognition Unit 104 performs an object recognition process, utilizing computer vision and/or other suitable methods, and generates a List of Objects-of-Interest 105. Such list indicates, for example: a serial number or ID number for each recognized object (e.g., object 1 being a goalkeeper; object 2 being a forward player); the in-frame location of the central pixel of the recognized object-of-interest, or a bounding box or bounding rectangle that contains the object and that is defined via parameters (e.g., coordinates of top-left corner and coordinates of top-right corner; or, coordinates of top-left corner, and rectangular length and rectangular width); such as, on a per-frame basis (e.g., in frame 1, the central pixel of object 1 (goalkeeper) is located at offset of 631 pixels horizontally from the left edge and at offset of 247 pixels vertically from the top edge); optionally, a textual description of the object (e.g., “goalkeeper” or “sports player”); optionally, indicators of an area-of-interest that surrounds that central pixel and that still depicts the object-of-interest (e.g., a rectangle of 278 by 507 pixels). The list may be represented (at least temporarily) as a lookup table, an XML file, a VTT file, a CSV file, a database having records or having rows and columns, or the like. The list may further indicate or represent, directly or indirectly, the flow or movement of an object-of-interest across frames or within the video; such as, indicating that Object 1 is generally moving from left to right across the video-segment that begins at Frame 150 and ands at Frame 240.

In some embodiments, optionally, the Object-of-Interest Recognition Unit 104 may take into account a textual description that was provided with the original video, or a contextual analysis of a file name or of metadata or other descriptors (e.g., a user-assigned Tag or Keyword or Title), as an assisting parameter which may be utilized to improve the object recognition; or a response to a question that is posed to the uploading user, requesting the user to select a general type of video that is being uploaded (e.g., “sports game”, or “fashion show”, or “classroom lecture”, or “virtual tour of a venue”); and such additional information, which may be optional, may be utilized to fine-tune the object recognition unit; for example, causing it to specifically search for (and detect or recognize) a ball in a sports game, or to specifically search for (and detect or recognize) clothing articles in a fashion show, or to specifically search for (and detect or recognize) a teacher and a blackboard in a classroom lecture, or the like. Such additional data may be extracted by a Contextual Analysis Unit 106, which may process such additional data to enhance the results of the object recognition process.

In some embodiments, optionally, Object-of-Interest Recognition Unit 104 may utilize input from a creator and/or uploader and/or editor and/or owner of the original video, indicating the existence and/or location and/or type of objects-of-interest and/or areas-of-interest that should be the subject of high-quality content-aware zoom-in functionality. In a first example, the uploader or creator of a video depicting a fashion show, may provide textual input indicating that it commands the system to actively search for objects that correspond to the keywords “skirt” and “handbag” and “face”, as zoomable objects-of-interest. In a second example, the video uploader or creator may be presented with a particular frame from the video, or may extract and provide a particular frame from the video, and may then highlight or mark on it manually an object-of-interest or an area-of-interest; such as, by drawing via an input unit a closed shape around a goalkeeper in a frame from a video of a soccer game, to indicate that the goalkeeper should be tracked as an object-of-interest. In a third example, the video uploader or creator may provide an input indicating that a particular sub-frame or region of the video, across the entire video or across a particular time-slot of the video, should be the subject of a zoom-in functionality; for example, indicating that “the top-right quarter” of the video contains an object-of-interest or should be defined as an area-of-interest for zoom-in purposes, or that the “central 1/9sub-frame in a 3×3 matrix of sub-frames” should be defined as an area-of-interest for zoom-in purposes.

A Video Downscaling Unit 107 generates from the original video a Downscaled Video Version 131 (e.g., a lower-resolution version; such as, generating a 480p video from an original 4K video), which still depicts the entire original field-of-view of the high-resolution video; or, in some implementations, which also performs resizing of the original video and/or insertion of “black bars” (horizontally or vertically). The Downscaled Video Version 131 is stored in the Video Repository 103. Optionally, several such downscaled video versions may be generated and stored; for example, an original 4K resolution (or an 8K resolution) video may be received; a first downscaled video version is generated at 1080p and is stored; a second downscaled video version is generated at 720p and is stored; a third downscaled video version is generated at 480p and is stored; each one of these downscaled video versions maintains and shows, for example, the entire original field-of-view that was depicted in the original (e.g., 4K or 8K) video.

A Video Cropping Unit 108 generates from the original video at least one, or several, Cropped Video Version(s) 132. Each of such Cropped Video Version(s) 132 may span, time-wise, the entire length of the original video; or may span only a partial time-slot from the original video (e.g., only 15 seconds out of an original 60-second video). Each of such Cropped Video Version(s) 132 is a cropped version of video frames, that depict one (or more) of the objects-of-interest that were recognized. For example, an original 4K video has 60 seconds, and depicts a fashion show; a handbag spans approximately 300×300 pixels of the 4K video, and appears during a time-segment that begins at the 13th second and ends at the 24th second; the Video Cropping Unit 108 generates an 11-second video segment, having a resolution of 480p, which is a cropped portion (854 by 480 pixels) of the original 4K video, which immediately surrounds the recognized object-of-interest (handbag). Additionally, the Video Cropping Unit 108 also generates a 55-second video segment, having a resolution of 480p, which is a cropped portion (854 by 480 pixels) of the original 4K video, which immediately surrounds another recognized object-of-interest (e.g., the face of the model on the runway). It is noted that in some embodiments, each such cropped video segment, is not a downscaled video segment, and is a non-downscaled video segment; but rather, it is a video segment comprised of non-downscaled frames of the original high-resolution video that were cropped (without downscaling) to the target resolution. The Video Cropping Unit 108 thus generates multiple cropped versions of variants, from the original high-resolution video, each such variant or version depicting a high-resolution cropped depiction of an object-of-interest (or an area-of-interest) and its immediate surrounding.

In some embodiments, a Cropping Parameters Determination Unit 109 may operate to determine which size and/or offset and/or portion of a video frame to crop, or to maintain within the cropped-in portion, or to discard as a cropped-out portion. For example, in some implementations, the Cropping Parameters Determination Unit 109 may utilize a cropping rule that indicates that cropping should be performed such that a target resolution (e.g., 480p) is cropped, with the central pixel of the cropped frame being located at the central pixel of the object-of-interest (e.g., a central pixel of the handbag is also a central pixel of the 480p cropped frame). In other implementations, a high-resolution frame may be divided into N sub-frames; such as, into 4 rectangles (arranged as 2×2), or 9 rectangles (arranged as 3×3), and the cropping may be performed by using such pre-defined sub-frames division or template, and by selecting the sub-frame (e.g., top-left sub-frame; central sub-frame; bottom-right sub-frame; or the like) that includes the entirety of the object-of-interest. In some implementations, the cropping may be performed using a moving crop-window or a moving cropping rectangle, which dynamically matches or follows or depicts the recognized object-of-interest that is the subject of that cropped version; such as, a cropping of a 4K video into a cropped rectangle of 480p which follows a handbag in a fashion show or which follows a goalkeeper in a soccer game. In some embodiments, optionally, an Object Tracking Unit 110 may be utilized to track the in-frame location of an object-of-interest across frames of the video; and the tracking output of such Object Tracking Unit 110 may be utilized by the Cropping Parameters Determination Unit 109 to dynamically move or adjust the location of the cropped sub-frame within the high-resolution video that is being cropped, which in turn may base the parameters (or the sub-frame coordinates for cropping purposes) on the output of the Object Tracking Unit 110 which tracks the object-of-interest across different frames of the same original high-resolution video.

For example, the original video may be a 4K video (high-resolution video with 3,840 by 2,160 pixels in each frame) of a soccer game; the object-of-interest may be a soccer ball, which has a diameter size of approximately 50 pixels; a cropped high-detail video may thus be generated at 480p resolution (854 by 480 pixels), tracking the soccer ball and its surrounding across the frames of the original video. For example, the soccer ball is kicked, and travels from the bottom-left corner to the upper-right corner, across three seconds of video, or across 90 frames (at 30 frames-per-second). Accordingly, the cropping sub-frame of 854 by 480 pixels also moves, across 90 frames, diagonally from south-west to north-east, from being located at the bottom-left corner of the 4K video, to gradually reaching the top-right corner of the 4K video, following the soccer ball and surrounding the soccer ball as it travels across those 90 frames.

Optionally, output from a Motion Smoothing Unit 111 may further be utilized for selecting the frame-portion of the high-resolution video that is selected from cropping-in the recognized object-of-interest; for example, to ensure that the object-of-interest would still be depicted as smoothly moving across frames of the cropped video version. In some embodiments, the object or the camera motion may be “jumpy” or may include abrupt changes or “jumps” in object location, and therefore raw tracking of the object itself might (in some situations) result in a “jumpy” output with some abrupt location-changes of the object; therefore, the Motion Smoothing Unit 111 may operate to create or emulate a smooth virtual camera motion that is more pleasant to the viewer. For example, an object has moved horizontally from left to right, and appeared with its left edge at an offset of 30 pixels from the left margin of the frame; and then appeared at an offset of 31 pixels from the left margin of the frame; and then jumped abruptly to be at an offset of 35 pixels from the left margin of the frame, and then continued to move and appeared at 36 and 37 pixels from the left margin of consecutive frames; the Motion Smoothing Unit 111 detects the abrupt jump or sudden change in the location of the object, and may (optionally) modify the video content by adjusting the location of the cropped rectangular box, such that the horizontal offset of the tracked object would change gradually and smoothly (e.g., offsets of 31, 33, 35, 37, 39), thereby generating a smoother and non-jumpy video content that is more pleasing to the viewer.

A Video Encoder 112 operates to encode short-duration video-segments, including the down-scaled version as well as cropped versions, which are all synchronized in time in order to allow smooth and seamless switching at the video playback device between a wide full field-of-view (FOV) version and a zoomed-in smaller-FOV version. For example, the original video is a 60-second 4K video. Video Encoder 112 determines (e.g., optionally by utilizing a Segmenter Unit 113 that divides the video into fragments or segments of equal length) that the video would be sliced into 60 segments, each video-segment spanning one second. Video Encoder 112 generates the downscaled video version, by producing 60 discrete (separate) video segments of a downscaled version (e.g., from 4K to 480p), each downscaled video segment corresponding to one second of the video. Furthermore, Video Encoder 112 generates a first cropped video version, at 480p resolution, by producing a first set of 60 discrete (separate) video segments of cropped videos (e.g., each one having a cropped 480p sub-frame from the original 4K frames, without downscaling), each cropped video segment corresponding to a first object-of-interest that was recognized in the video (e.g., depicting the goalkeeper in a soccer game). Video Encoder 112 further generates a second cropped video version, at 480p resolution, by producing a second set of 60 discrete (separate) video segments of cropped videos (e.g., each one having a cropped 480p sub-frame from the original 4K frames, without downscaling), each cropped video segment corresponding to a second object-of-interest that was recognized in the video (e.g., depicting the forward player in that soccer game). Additionally, Video Encoder 112 generates a third cropped video version, at 480p resolution, by producing only 14 discrete (separate) video segments of cropped videos (e.g., each one having a cropped 480p sub-frame from the original 4K frames, without downscaling), each cropped video segment corresponding to a third object-of-interest that was recognized in the video and that appears only during the 14 seconds that being at the 25th second of the original video and that end at the 39th second of the original video (e.g., depicting the referee in that soccer game). The multiple versions of the video segments are stored, at least temporarily, in Video Repository 103.

A Metadata List Generator 114 generates a Metadata List 115 (or file, or data-item), which is associated with the video, and which indicates the available cropped version(s) that are available for each frame (or time-slot, or time-segment) of the video; and optionally indicating also the in-frame coordinates or location or offset of such cropped versions (e.g., relative to a first horizontal edge and to a first vertical edge of the original video; or otherwise relative to a fixed point or a particular corner of the full uncropped video).

A Manifest File Generator 116 generates a Manifest File 117, such as using MPEG DASH format or M3U format or M3U8 format. The Manifest File 117 represents or indicates the addresses and/or metadata of the available video segments; for example, indicating that a full FOV version of 480p is available for the entire 60 one-second segments, and indicating that a first cropped 480p version is available for the entire 60 one-second segments that depict Object-of-Interest 1, and indicating that a second cropped 480p version is available for the entire 60 one-second segments that depict Object-of-Interest 2, and indicating that a third cropped 480p version is available for 14 one-second segments that depict Object-of-Interest 3 (spanning the 25th to the 38th one-second video segments). The Manifest File 117 may indicate the URL or URI for each such video segment, and its relevant metadata. The Manifest File 117 may be stored in the Video Repository 103, as a separate file that is associated with (or linked to) the original video; or as a “sidecar” file that accompanies the original video; or, in some implementations, as metadata within a header of the video file itself; or using a database or a lookup table or pointer(s); or using other suitable methods that associated between a particular video and a particular manifest file.

In some embodiments, the above-described video processing and video versions generation process may be performed by Video Management Server 102 in non-real-time; such that, for example, the High-Resolution Video 130 is firstly uploaded or copied to the server or to the video repository 103, and is then processed as described to generate the multiple versions, which are then stored as multiple versions of video-segments. In some embodiments, the above-described video processing and video versions generation process may be performed by Video Management Server 102 in real-time and/or on-the-fly and/or on demand, such that, for example, the High-Resolution Video 130 is firstly uploaded; a downscaled full-FOV version is generated and served; and, upon receiving a client-side request or command to perform a zoom-in operation, the Video Management Server 102 rapidly generates cropped video versions of not-yet-played video segments (or, of video segments of the entire video being played), and such cropped video versions become available in the background while the end-user is watching the video, and the zoom-in functionality becomes available a short time-period (e.g., 1 or 2 seconds) after receiving the user request; and newly cropped video segments are being generated by the server while the end-user device is playing some of the already-generated cropped video segments of preceding time-segments of the video.

For example, in a demonstrative implementation, the end-user device is playing a video of 60 seconds; at time-point 00:13 (mm:ss), the end-user requests zoom-in; the server immediately starts generating cropped video versions, for one-second time-segments from that time-point and onward; the first cropped video version is available after two seconds of processing, and starts displaying at time-point 00:15; during its playback (from time-point 00:15 to time-point 0016), the next five video-segments are generated as cropped versions, and become available for zoomed-in playback; during the playback of those five video-segments, the next 12 video-segments are generated as cropped versions; and so forth, thereby producing on-the-fly the cropped video-segments in response to a triggering command (a zoom-in command or request) from the end-user device. Similarly, the Metadata List 115 and/or the Manifest File 117 may be constructed and/or updated and/or augmented on-the-fly, in the background while the end-user device is playing the already-generated cropped video segments; thereby providing a zoom-in functionality that is triggered by an initial zoom-in command, and is constructed gradually via background server-side processing while the end-user device displays already-generated cropped (and thus zoomed-in) video segments.

System 100 further comprises an End-User Device 150, which may be an electronic device or a computerized device capable of playing video; for example, a smartphone, a tablet, a laptop computer, a desktop computer, a smart-watch, a wearable device, an Augmented Reality (AR) helmet or headset or glasses or gear, a Virtual Reality (VR) helmet or headset or glasses or gear, a smart television, a smart display unit, an Internet connected display unit, or dedicated video playback device, or the like.

End-User Device 150 may request a video for local playback or consumption, directly and/or indirectly from Video Management Server 102 and/or Video Repository 103; or may request or obtain such video via a Content Delivery Network (CDN), or via a cloud computing system, or from a cloud hosting system. In some embodiments, optionally, End-User Device 150 may be co-located with, or may be in proximity to, Video Management Server 102 and/or Video Repository 103; such as, when these units are part of an organizational network or an enterprise network.

End-User Device 150 may comprise a Video Playback Unit 151, optionally implemented (or including) a video playback application or “app”, or optionally implemented as a web browser or as a plug-in or add-on or extension to a web browser (or to another type of application), or optionally implemented as a stand-alone program or as a component of another application. The Video Playback Unit 151 obtains or downloads the Manifest File 117 of the particular video intended for consumption; and parses the content of the Manifest File 117 and the metadata thereof, to determine which video versions are available for this particular video. Optionally, the Video Playback Unit 151 may visually indicate to the end-user, via a Zoomable Objects Marking/Highlighting Unit 153, the existence and/or the location of particular objects-of-interest that are zoomable (e.g., objects for which a high-quality fine-details zoom-in function is available, throughout the video or throughout particular portions of the video). In a first example, the Video Playback Unit 151 may indicate via colorful on-screen rectangles (or circles, or arrows) the objects-of-interest that are zoomable (e.g., encircling or surrounding or pointing to the shoes, the handbag, and the skirt in the fashion show video; or, encircling or surrounding or pointing to the goalkeeper, the referee, and the soccer ball in the soccer game video). In some embodiments, such highlighting or encircling may be achieved by generating an over-layer that is presented on top of the video, optionally having partial opacity or transparency to allow viewing of the underlying video; or by causing the mouse-pointer or the on-screen pointer (e.g., via a script or code, via a JavaScript “on hover” function, or via other means) to change its appearance when it hovers over a particular object or a zoomable object or a particular frame-region or a zoomable frame-region. In some embodiments, arrows or pointers may be displayed externally to the video, pointing towards the direction of the objects that are zoomable. In some embodiments, textual tags or keywords, or graphical icons, may be presented near or beneath the video (such as “goalkeeper” and “referee” keywords or tags), each such keyword or tag corresponding to a different recognized object-of-interest. In some embodiments, no such on-screen visual markings or visual emphasizing elements are displayed at all; but rather, the end-user is expected to freely select an object for zoom-in functionality, without necessarily hinting to the end-user which objects are zoomable and which are not. In still other embodiments, on-screen emphasizing elements and/or highlighting elements are displayed to the end-user only for a short time-period (e.g., for two seconds upon the first appearance of each such object-of-interest), and are then removed or deleted, in order to provide an initial and temporal indication or hint about the existence and/or location of zoomable content portions.

In some embodiments, engagement of the end-user with such marking or indication of an object-of-interest, causes the Video Playback Unit 151 to perform or to initiate the high-quality zoom-in process with regard to that object-of-interest. The engagement by the user may be performed via a suitable UI or GUI element and/or input unit, which may be monitored by a Zoom-In Functionality Unit 154 which may be responsible for generating and displaying such UI/GUI element(s), obtaining the user command(s) through them, and then triggering a Video Version Switching Unit 155 (or, a Video Stream Switching Unit) to switch from a first video version (or video stream) to a second (e.g., zoomed-in or zoomed-out) video version (or video stream). Each video stream or video version may be pre-segmented into video-segments of equal time; such that the time-period of video segments are uniform across all the available video streams (or video versions) generated for the same original video; such that the playback switching may be performed seamlessly and dynamically during actual playback of the video; for example, stopping the playback of the switched-out video stream (or video version) at time-point T, and immediately starting the playback of the switched-in video stream (or video version) from that same time-point T thereof and onward. For example, if N video-segments of the first video stream have elapsed when the user command for switching (zoom-in) was received, then the playback of the switched-in video stream (e.g., the zoomed-in video stream) will commence at video-segment number N+1 of that switched-in video stream, or from the relevant time-point of that switched-in video stream which corresponds to the time-point in which the user command was received.

For example, User Adam may utilize his smartphone to view the video of the soccer game; and may use his finger(s) to tap (or to double-tap, or to perform a zoom-in pinch-apart motion with two fingers) via his touch-screen on the visual highlighting indication that surrounds the referee in the video. Similarly, User Bob may utilize his tablet to view the same video of the soccer game; and may use a stylus to tap on the depiction of the goalkeeper during the video playback, even without having any marking or emphasis of the fact that the goalkeeper is a zoomable object-of-interest. Similarly, User Carla may utilize her computer mouse to click on an object-of-interest in the playing video, either based on a visual hint that indicates its location, or based on a textual link that mentions its existence, or without any such hints or marking. Optionally, User Diana may utilize a speech-based interface, to convey a verbal command of “zoom-in on the referee”; and a speech-to-text converter or unit may recognize and extract the relevant command and provide it to the Video Playback Unit 151 for processing (e.g., such speech-to-text converter being located and running in the End-User Device 150; or, invoked or running on a remote device or a cloud computing unit; or, invoked by or running on a smart home hub or a home automation unit or a smart digital assistant unit, such as Apple Ski or Google Assistant or Amazon Alexa).

In response to such user command, the Video Playback Unit 151 determines which particular object-of-interest (or, area-of-interest) is the subject of the zoom-in request; and obtains from the Manifest File 117 and/or from the Metadata List 115 the pointer(s) to the subsequent video segments that depict the cropped version of that particular object-of-interest. For example, during playback of a 60-second video of a soccer game, at time point 00:15 the end-user conveys via the Video Playback Unit 151 a command to perform zoom-in on the referee. In some embodiments, the Video Playback Unit 151 analyzes the Manifest File 117 of that video; determines that there exist video-segments of the cropped referee area, for time-slots 12 through 39 of that 60-second video; and starting at time-point 00:16, the Video Playback Unit 151 obtains and displays (plays back) those video-segments of that cropped video version that correspond to the referee object-of-interest. Optionally, a smooth transition effect may be implemented and dynamically generated and displayed as part of the video playback, such as by a Smooth Video Transition Generator 156, during the 15th second of the video playback, to provide an on-screen animated transition or gradual transition or smooth transition or a gradual zoom-in effect which transitions the view from the original full-FOV display (at time-point 00:15) to the zoomed-in cropped FOV display (which starts at time-point 00:16).

In the above demonstrative example, Video Playback Unit 151 then continues to obtain and to display the cropped zoom-in video segments, until a switching event occurs which triggers a switch or a change. A first type of a switching event is, for example, that the end-user performed or conveyed a zoom-out command (e.g., performed a pinch-in gesture or a pinch-together on the touch-screen; or clicked on a “zoom out” button, or clicked on a magnifying glass icon with a minus sign inside it); thereby indicating his desire to end the zoom-in functionality. A second type of a switching event is, for example, that this particular video no longer has cropped versions for that particular zoomed-in object-of-interest, such as, this object-of-interest (e.g., the referee) is no longer within the original full FOV. A third type of a switching event is, for example, that the end-user has conveyed a command to perform a zoom-in on another, different, object-of-interest (e.g., the goalkeeper, or the soccer ball); such as, by tapping or pinching on that other object, or by conveying a voice command (e.g., “zoom-in on the goalkeeper”), or by clicking or double-clicking with his computer mouse on the goalkeeper, or by clicking or tapping on the keyword or tag “goalkeeper”, or the like. The switching events may be handled by Video Version Switching Unit 155 based on one or more pre-defined video version switching rules, or based on user-configurable video version switching rules or switching parameters.

Upon the detection of such switching event, the Video Playback Unit 151 may rapidly yet seamlessly switch to a different version of the video; for example, it may switch to the full FOV version (the downscaled version) of the video in response to a zoom-out command, or in response to a “stop the zoom-in” command, or in response to a detection that there are no more video segments available for that zoomed-in object-of-interest; or, it may switch to a different cropped video version that provides a zoom-in on the goalkeeper (instead of the referee) in response to a user command to switch from a zoom-in on the referee to a zoom-in on the goalkeeper. Optionally, the transition from playback of video segments of a zoomed-in object-of-interest, to playback of the full FOV video segments (or, to playback of video segments of another, different, zoomed-in object of interest) may be a smooth visual transition, implemented via an on-screen zoom-in/zoom-out effect or animation.

Accordingly, Video Playback Unit 151 operates to obtain and parse the Manifest File 117, to parse the Metadata List 115, via a Manifest/Metadata Parsing Unit 152; and proceeds to utilize those information items in order to generate and display User Interface (UI) or Graphical User Interface (GUI) elements that indicate the zoomable objects or areas, and/or that indicate their existence and/or location, and/or that facilitate the engagement of the user with such zoomable elements, or that otherwise facilitate the ability of the user to convey a zoom-in command with regard to a particular object or area.

For example, Video Playback Unit 151 receives the end-user command for zooming-in on a particular object or area that is depicted in the played video; and requests the appropriate zoomed-in and cropped set of video segments from the video server; and implements a seamless visual transition between playing the full-FOV video and playing the zoomed-in video segments; and implements a seamless visual transition between playing the zoomed-in video segments and playing the full-FOV video; and implements a seamless visual transition between playing the zoomed-in video segments that correspond to object-of-interest A and playing the zoomed-in video segments that correspond to object-of-interest B. Such smooth transition effects may be implemented via transition effect rendering algorithms, via animation that mimics a zoom-in or a zoom-out effect, via visual effect(s) that simulate a gradual zoom-in or a gradual zoom-out effect, or the like. Once the currently-playing stream of video segments terminates, for example due to an object that no longer appears in the video, Video Playback Unit 151 automatically switches back to the full FOV video version; or, in some implementations, based on configurable settings, may optionally loop and replay the zoomed-in video portion.

In some embodiments, optionally, End-User Device 150 may comprise Video Playback Unit 151 which may be implemented as a Web Browser 157 capable of obtaining and/or playing multimedia content and/or videos, or as an integral component of such web browser, or as a plug-in or extension or add-on to such web browser.

In some embodiments, optionally, End-User Device 150 may comprise Video Playback Unit 151 which may be implemented as a stand-alone application or “app”, or as a mobile application or a “mobile app”, or which may be implemented via HTMLS and/or JavaScript and/or CSS as an interactive web-page able to obtain and/or play multimedia content and/or videos.

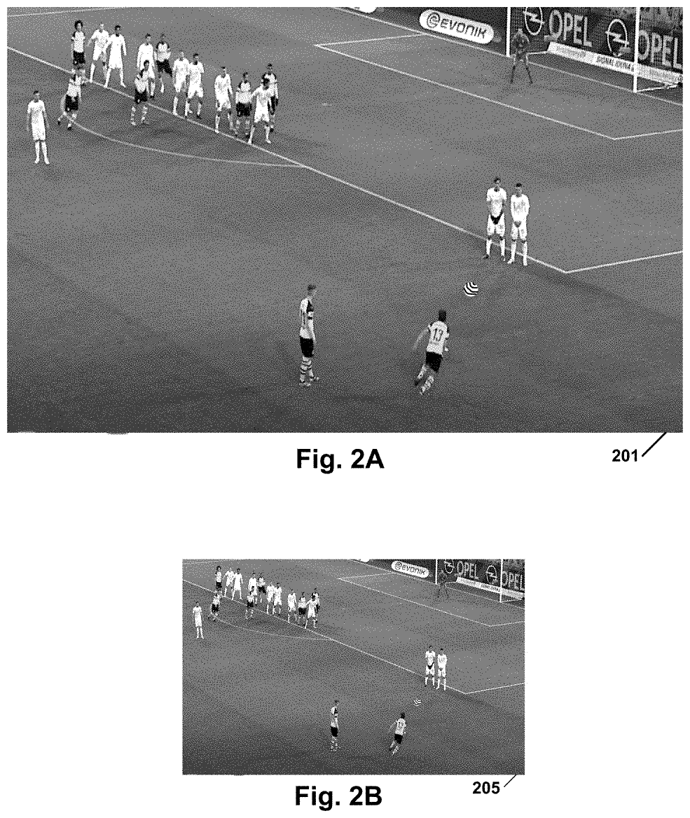

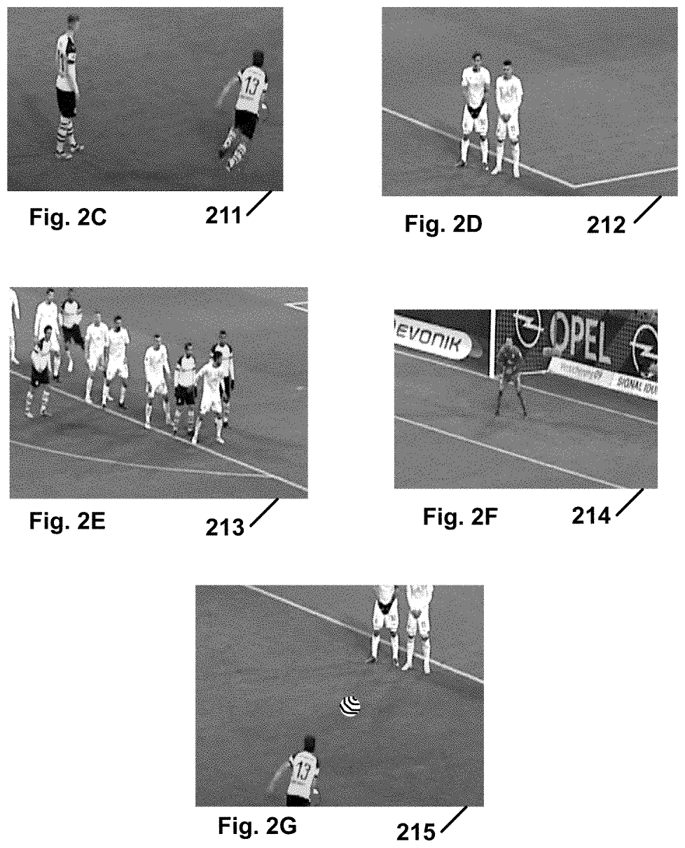

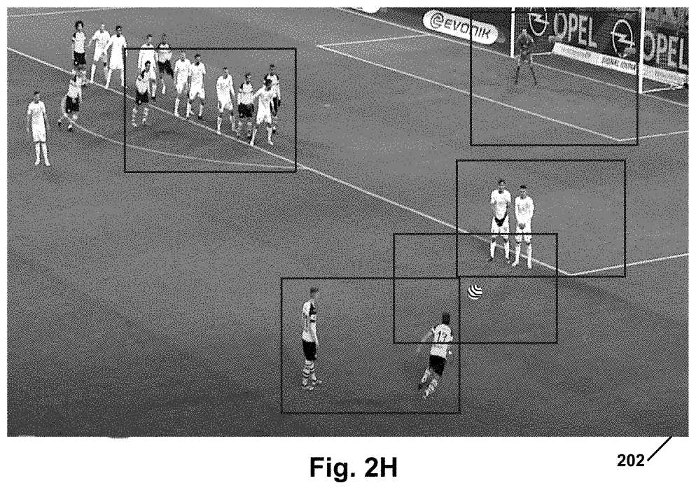

Reference is made to FIGS. 2A-2G, which are illustrations of frames from different versions of a video of a soccer game, as processed and/or produced by a system in accordance with some demonstrative embodiments.

FIG. 2A shows an original frame 201 from an original high-resolution video, such as, having a 4K resolution (e.g., a frame of 3,840 by 2,160 pixels). The original video, at such high resolution, shows the entire scene or the full FOV that was captured; but it is often not suitable for streaming on a smartphone having a cellular connection, particularly at times in which the network is relatively busy or congested.

FIG. 2B shows a frame 202 from a downscaled version of the original video: The system may produce a scaled-down version of the original video, which looks similar to the version illustrated in FIG. 2A, but at a lower resolution, such as 480p or 720p, intended for consumption on mobile devices and/or when the bandwidth is limited. The scaled-down version, illustrated as frame 202, shows the full scene or the full FOV as captured in the original video, but at a lower resolution which loses or discards some of the intricate visual details. For example, the original high-resolution video may show a person wearing a shirt having a pocket; and the scaled-down lower-resolution video may still show the person wearing the shirt, but the pocket of the shirt may not be visible at all as a separate item, or may be difficult for comprehension as it may appear as a single pixel or as two pixels.

FIG. 2H shows a frame 205, which is a copy of the original high-resolution frame, with five in-frame indications of objects-of-interest or areas-of-interest that were determined for the original frame; each such area-of-interest being a rectangle having dimensions of 480p (e.g., each sub-frame is 854 by 480 pixels). In some embodiments, a human user may manually create these particular sub-frames, focusing on particular objects or areas. In other embodiments, an automated computer vision unit may analyze the original high-resolution video and may determine, in a content-aware process, which objects (or areas) are of interest for high-quality zoom purposes. In other embodiments, the object recognition process may optionally utilize hints or keywords or tags, entered manually by a user or obtained from a filename or a video title or from metadata; such that a filename or a keyword of “soccer game” may cause the automated unit to search for, and to track across frames, visual elements that are typically associated with such topic, such as a soccer ball or a soccer player or a referee or a goalkeeper; optionally utilizing a pre-defined lookup table or taxonomy database that associates between titles (or keywords) and relevant or typical visual elements.

FIG. 2C shows a frame 211 from a video version, prepared by cropping a 480p rectangle from the original 4K video, surrounding two forward soccer players; this video version tracking those two soccer players as an object-of-interest; thus enabling the end-user to request a zoom-in, relative to the original video, and such zoom-in causes a switch to playback of this cropped video version.

FIG. 2D shows a frame 212 from another video version, prepared by cropping a 480p rectangle from the original 4K video, surrounding two defending soccer players; this video version tracking those two soccer players as an object-of-interest; thus enabling the end-user to request a zoom-in, relative to the original video, and such zoom-in causes a switch to playback of this cropped video version.

FIG. 2E shows a frame 213 from another video version, prepared by cropping a 480p rectangle from the original 4K video, surrounding several other defending soccer players standing as a group; this video version tracking those several soccer players as an object-of-interest; thus enabling the end-user to request a zoom-in, relative to the original video, and such zoom-in causes a switch to playback of this cropped video version.

FIG. 2F shows a frame 214 from another video version, prepared by cropping a 480p rectangle from the original 4K video, surrounding the goalkeeper; this video version tracking that goalkeeper as an object-of-interest; thus enabling the end-user to request a zoom-in, relative to the original video, and such zoom-in causes a switch to playback of this cropped video version.

FIG. 2G shows a frame 215 from another video version, prepared by cropping a 480p rectangle from the original 4K video, surrounding the soccer ball; this video version tracking the soccer ball as an object-of-interest; thus enabling the end-user to request a zoom-in, relative to the original video, and such zoom-in causes a switch to playback of this cropped video version.

Each one of the cropped video versions, that are illustrated (separately) via frames 211-215, is a high-detail cropped version that was cropped from the original high-resolution video (and not from a downscaled version of the original high-resolution video); and thus, each such cropped video version maintains the full visual details and detail level as captured originally in the full-scene high-resolution video, while also reducing the pixel count and the required bandwidth for video transport due to the cropping around the object-of-interest; thus enabling the end-user to select to zoom-in or to visually focus on an object-of-interest that maintains its full details, and enabling the end-user to switch among such video versions or video streams.

In some embodiments, the size or the resolution of each one of the cropped versions may be identical to each other; such as, producing five versions of different 480p cropped regions, from the original 4K video, each such cropped version tracking an object-of-interest in the video in a dynamic content-aware movement of the cropped region within the original high-resolution video. In other embodiments, the size or the resolution of each one of the cropped versions need not be uniform or constant, or may be varying or different from cropped version to cropped version; for example, taking into account also the size (e.g., in pixels, or in percentage of the original high resolution frame) of each object-of-interest.

In accordance with some embodiments, if the particular portion of the Field of View (FOV) that is of interest for tracking, cannot fit into the display resolution or the delivered resolution, then a downscaling unit may apply downscaling to the relevant video segments or frames. Two different sets of considerations and parameters may be used, to achieve the relevant resolutions by the system. The displayed resolution (or the delivered resolution) is determined based on the available display size of the end-user device and based on the bandwidth or throughput of the communication link or network; whereas, the particular frame-portion or frame-region, which is cropped from the entire original FOV and which becomes the cropped FOV or which becomes the FOV-of-interest, is determined by analysis of the content of the scene depicted in the frame (or video) and by detection and tracking of an object-of-interest. If the cropped scene (showing only the FOV of interest) does not fit within the size of the delivered resolution, then the system may downscale it to fit, similarly to a downscaling that is performed by the system when the full FOV is requested and delivered. The system generates multiple versions of the original video (or, of time-segments thereof), and may deliver one or more of those versions to the end-user device or the playback device in order to meet the needs and the constraints of such device and its available bandwidth. The system may select interesting parts or portions of the video, crop them to show the object-of-interest, and if required then also downscale the frames showing the cropped FOV or the cropped object-of-interest, to fit the delivered resolution.

For example, an original video was a 4K video; the system may detect two different objects-of-interest (Object A and Object B) for tracking; the system may thus prepare Six new versions from the original 4K video: (a) a first video version that tracks (via cropping) Object A at 480p resolution; (b) a second video version that tracks (via cropping) Object A at 720p resolution; (c) a third video version that tracks (via cropping) Object B at 480p resolution; (d) a fourth video version that tracks (via cropping) Object B at 720p resolution; (e) a fifth video version showing the full non-cropped field-of-view of the original scene, downscaled from 4K resolution to 720p resolution; (f) a sixth video version showing the full non-cropped field-of-view of the original scene, downscaled from 4K resolution to 480p resolution. These six video versions are non-limiting examples; other video versions may be generated and later streamed, at other resolutions (e.g., full field-of-view, downscaled from 4K resolution to 1080p resolution; a cropped video version that crops and tracks Object A at 1080p resolution; a cropped video version that crops and tracks Object B at 1080p resolution; or the like).

The following code portion, denoted Code 1, is a demonstrative example of an HLS manifest, which may be generated and utilized in accordance with some embodiments. For example, an original video is a high-resolution video of a soccer game, accompanied by an audio stream. The manifest includes data representing the single audio stream, and six different versions of video streams from which the end-user device may select one for obtaining and playing.

#EXTM3U
#EXT-X-MEDIA:TYPE=AUDIO, GROUP-ID=“audio”,
LANGUAGE=“eng”, NAME=“English”,
AUTOSELECT=YES, DEFAULT=YES,
URI=“https://VideoRepository.com/soccergame/audio_stream.m3u8”
#EXT-X-STREAM-INF: BANDWIDTH=973697, RESOLUTION=1280x720,
CODECS=“avc1.42e00a”, AUDIO=“audio”
https://VideoRepository.com/soccergame/video_stream1.m3u8
#EXT-X-STREAM-INF: BANDWIDTH=1947394, RESOLUTION=1920x1080,
CODECS=“avc1.640028”, AUDIO=“audio”
https://VideoRepository.com/soccergame/video_stream2.m3u8
#EXT-X-STREAM-INF: BANDWIDTH=973697, RESOLUTION=1280x720,
CODECS=“avc1.42e00a”, ZOOM=“kicker”, AUDIO=“audio”
https://VideoRepository.com/soccergame/kicker1.m3u8
#EXT-X-STREAM-INF: BANDWIDTH=1947394, RESOLUTION=1920x1080,
CODECS=“avc1.640028”, ZOOM=“kicker”, AUDIO=“audio”
https://VideoRepository.com/soccergame/kicker2.m3u8
#EXT-X-STREAM-INF: BANDWIDTH=973697, RESOLUTION=1280x720,
CODECS=“avc1.42e00a”, ZOOM=“goalkeeper”, AUDIO=“audio”
https://VideoRepository.com/soccergame/goalkeeper1.m3u8
#EXT-X-STREAM-INF: BANDWIDTH=1947394, RESOLUTION=1920x1080,
CODECS=“avc1.640028”, ZOOM=“goalkeeper”, AUDIO=“audio”
https://VideoRepository.com/soccergame/goalkeeper2.m3u8
Code 1

The six versions of video in this demonstrative manifest of Code 1, in their order:
(1) full scene, full original FOV, no cropping, downscaled to 720p;
(2) full scene, full original FOV, no cropping, downscaled to 1080p;
(3) a cropped video version at 720p resolution of the ball kicker as the object-of-interest;
(4) a cropped video version at 1080p resolution of the ball kicker as the object-of-interest;
(5) a cropped video version at 720p resolution of the goalkeeper as the object-of-interest;
(6) a cropped video version at 1080p resolution of the goalkeeper as the object-of-interest.

Each one of the streams points to a detailed segment manifest.

Code 2 is a demonstrative example of a segment manifest:

#EXTM3U
#EXT-X-VERSION: 6
#EXT-X-TARGETDURATION: 4
#EXT-X-MEDIA-SEQUENCE: 0
#EXT-X-PLAYLIST-TYPE: VOD
#EXT-X-MAP:URI=“video_stream1/init.mp4”
#EXTINF:4.000000,
video_stream1/0.m4s
#EXTINF:4.000000,
video_stream1/1.m4s
#EXTINF:4.000000,
video_stream1/2.m4s
#EXTINF:4.000000,
video_stream1/3.m4s
#EXTINF:4.000000,
video_stream1/4.m4s
#EXTINF:4.000000,
video_stream1/5.m4s
#EXT-X-ENDLIST
Code 2

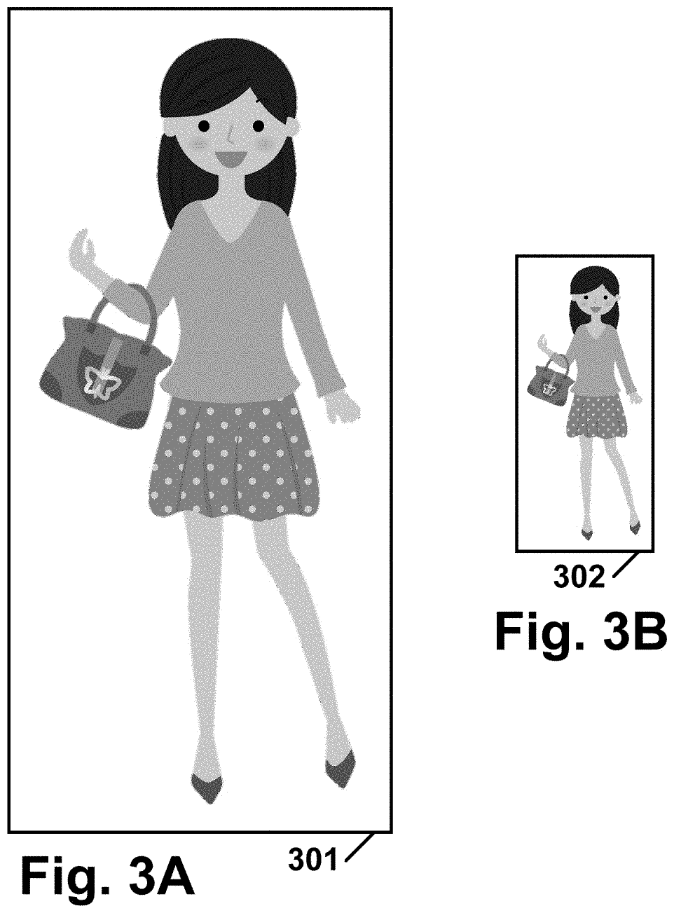

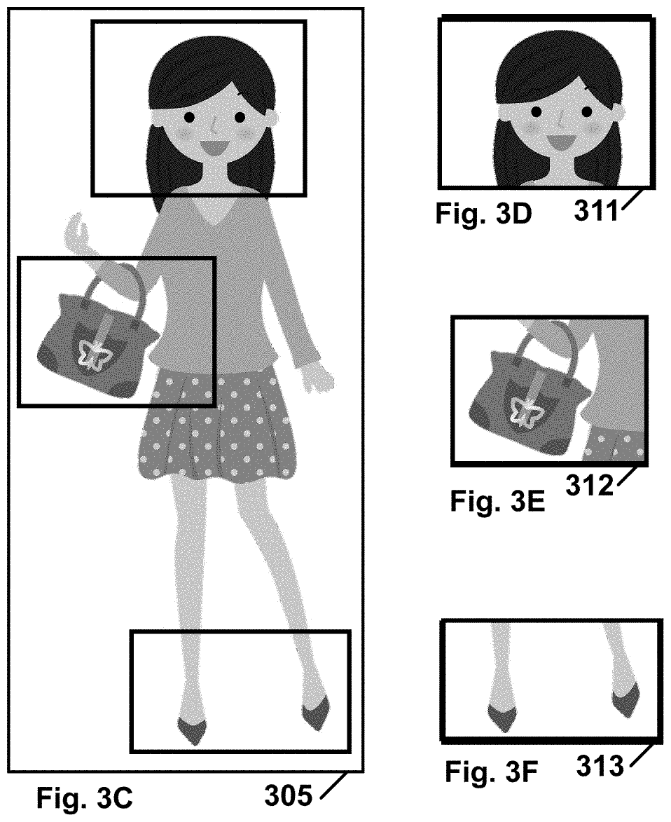

Reference is made to FIGS. 3A-3F, which are illustrations of frames from various versions of video of fashion show, as processed and/or produced by a system in accordance with some demonstrative embodiments.

FIG. 3A shows an original frame 301 from an original high-resolution video, such as, having a 4K resolution (e.g., a frame of 3,840 by 2,160 pixels). The original video, at such high resolution, shows the entire scene or the full FOV that was captured; but it is often not suitable for streaming on a smartphone having a cellular connection, particularly at times in which the network is relatively busy or congested.

FIG. 3B shows a frame 302 from a downscaled version of the original video: The system may produce a scaled-down version of the original video, which looks similar to the version illustrated in FIG. 3A, but at a lower resolution, such as 480p or 720p, intended for consumption on mobile devices and/or when the bandwidth is limited. The scaled-down version, illustrated as frame 302, shows the full scene or the full FOV as captured in the original video, but at a lower resolution which loses or discards some of the intricate visual details. For example, the original high-resolution video may show a decoration on the handbag, or a ribbon in the hair; and the scaled-down lower-resolution video may lose such fine details as a separate item, or may include them as few pixels that are difficult for comprehension.

FIG. 3C shows a frame 305, which is a copy of the original high-resolution frame, with three in-frame indications of objects-of-interest or areas-of-interest that were determined for the original frame; each such area-of-interest being a rectangle or other polygon or shape; having dimensions of 480p (e.g., each sub-frame is 854 by 480 pixels), or having other suitable dimensions that need not necessarily be 480p (for example, the indication may be a rectangular border having an area or a size of one-quarter of 480p, or one-half of 480p, or one-fifth of 480p, thereby keeping the target aspect ratio of 480p in order to hint to the user what would be the aspect ratio of the zoomable frame-portion; or, in some embodiments, the on-screen indication or marking of the trackable/zoomable object-of-interest need not necessarily have the same aspect ratio of the video segment version that indeed tracks that object-of-interest, such as, the full FOV video may show a square-shaped box around a soccer ball that is zoomable/trackable, even if the video version that tracks that soccer ball is a 480p video version that is non-square). In some embodiments, a human user may manually create these particular sub-frames, focusing on particular objects or areas. In other embodiments, an automated computer vision unit may analyze the original high-resolution video and may determine, in a content-aware process, which objects (or areas) are of interest for high-quality zoom purposes. In other embodiments, the object recognition process may optionally utilize hints or keywords or tags, entered manually by a user or obtained from a filename or a video title or from metadata; such that a filename or a keyword of “fashion show” may cause the automated unit to search for, and to track across frames, visual elements that are typically associated with such topic, such as a handbag or shoes or clothing articles; optionally utilizing a pre-defined lookup table or taxonomy database that associates between titles (or keywords) and relevant or typical visual elements.

FIG. 3D shows a frame 311 from a video version, prepared by cropping a 480p rectangle from the original 4K video, surrounding the face of the fashion model; this video version tracking the face as an object-of-interest; thus enabling the end-user to request a zoom-in, relative to the original video, and such zoom-in causes a switch to playback of this cropped video version.

FIG. 3E shows a frame 312 from another video version, prepared by cropping a 480p rectangle from the original 4K video, surrounding the handbag held by the fashion model; this video version tracking the handbag as an object-of-interest; thus enabling the end-user to request a zoom-in, relative to the original video, and such zoom-in causes a switch to playback of this cropped video version.

FIG. 3F shows a frame 313 from a video version, prepared by cropping a 480p rectangle from the original 4K video, surrounding the shoes of the fashion model; this video version tracking the shoes as an object-of-interest; thus enabling the end-user to request a zoom-in, relative to the original video, and such zoom-in causes a switch to playback of this cropped video version.

Code 3 demonstrates metadata of multiple objects tracking; for demonstrative purposes, two objects (face and handbag) are tracked in the object tracking metadata Code 3:

WEBVTT
1
00:00:00.000 −−> 00:00:00.020
[{“ObjID”: “face”, “left”: “36.04”, “top”: “15.75”, “width”:
“28.42”, “height”: “10.84”},
{“ObjID”: “handbag”, “left”: “31.66”, “top”: “72.88”, “width”:
“33.42”, “height”: “9.71”}]
2
00:00:00.020 −−> 00:00:00.040
[{“ObjID”: “face”, “left”: “35.69”, “top”: “15.75”, “width”:
“28.77”, “height”: “10.84”},
{“ObjID”: “handbag”, “left”: “31.66”, “top”: “82.72”, “width”:
“33.42”, “height”: “9.86”}]
3
00:00:00.040 −−> 00:00:00.060
[{“ObjID”: “face”, “left”: “35.52”, “top”: “15.75”, “width”:
“28.94”, “height”: “10.84”},
{“ObjID”: “handbag”, “left”: “31.66”, “top”: “72.60”, “width”:
“33.42”, “height”: “9.99”}]
4
00:00:00.060 −−> 00:00:00.080
[{“ObjID”: “face”, “left”: “35.43”, “top”: “15.75”, “width”:
“29.03”, “height”: “10.84”},
{“ObjID”: “handbag”, “left”: “31.66”, “top”: “72.50”, “width”:
“33.42”, “height”: “10.09”}]
5
00:00:00.080 −−> 00:00:00.100
[{“ObjID”: “face”, “left”: “35.39”, “top”: “15.75”, “width”:
“29.07”, “height”: “10.84”},
{“ObjID”: “handbag”, “left”: “31.66”, “top”: “72.42”, “width”:
“33.42”, “height”: “10.17”}]
6
00:00:00.100 −−> 00:00:00.120
[{“ObjID”: “face”, “left”: “35.37”, “top”: “15.75”, “width”:
“29.09”, “height”: “10.89”},
{“ObjID”: “handbag”, “left”: “31.66”, “top”: “72.28”, “width”:
“33.42”, “height”: “10.31”}]
...
Code 3

The metadata file of Code 3 describes a video with two tracked objects: a face, and a handbag. The metadata file informs the video player (on the end-user device) which objects are available for zooming-in at any specific time-point, and further informs about the spatial position (e.g., coordinates) of each such zoomable object within the frame. If an end-user who views the video selects to zoom-in, the video player proceeds to obtain the appropriate video segment from the server for playback.

In some embodiments, for each time segment in the video file, object location metadata is added, for example, automatically by object detection algorithm (e.g., based on AI or ML or computer vision) and/or manually (e.g., by the creator or editor of the video, using an editing software). The metadata may be saved and delivered to the end-user device in one or more formats or as one or more data-items, for example, using Webvtt, JSON, XML, a CSV file, or other suitable format.

In a demonstrative example, the metadata may include at least the following information fields: (a) Time-Period, such as, represented in hh:mm:ss:mmm, wherein “mmm” counts milliseconds; (b) Object-ID, indicating an identification name for the object (e.g., “handbag” or “shoes” or “face”); (c) Object-Position, indicating the sub-frame region which visually corresponds to that object.

The Object-Position may be represented in accordance with a suitable representation scheme; for example, one of the following: (i) Defining a rectangle by two corners (x1, y1, x2, y2), wherein [x1, y1] are the coordinates of the top-left corner of a rectangle containing the object, and wherein [x2, y2] are the coordinates of the bottom-right corner of that rectangle containing that object. (ii) Defining a rectangle by the coordinates of its top-left corner, as well as the rectangle's width and height (x1, y1, w, h), which is the representation scheme utilized in Code 3 above; (iii) Defining a rectangle by the coordinates of its center point, as well as the rectangle's width and height (x, y, w, h), wherein [x, y] are also the coordinates of the center of the object. In some embodiments, coordinates are represented as percentage from the overall width and height of the total FOV, or as percentage of the total FOV; as such percentage-based parameters, indicated as percentages of the total FOV, allow decoupling from the absolute pixel-based sizes of the particular video segment. In some embodiments, multiple different objects may be tracked for each video frame.

In some embodiments, a method comprises: (a) receiving an input video file comprising at least an input video stream (V0) having an input video resolution (R0) comprising an input width in pixels (W0) and an input length in pixels (L0); (b) generating from said input video stream (V0) a first generated video stream (V1), which is a downscaled and non-cropped version of an entire field-of-view of said input video stream (V0), wherein the first generated video stream (V1) has a first video resolution (R1) that is smaller than the input video resolution (R0), wherein the first video resolution (R1) has a width in pixels (W1) that is smaller than the input width in pixels (W0), wherein the first video resolution (R1) has a length in pixels (L1) that is smaller than the input length in pixels (L0); (c) generating from said input video stream (V0) a second generated video stream (V2), which is a non-downscaled cropped region of only a partial field-of-view of said input video stream (V0), wherein the second generated video stream (V2) has said first video resolution (R1) that is smaller than the input video resolution (R0); wherein the second video stream (V2) tracks an object-of-interest that is visually depicted in said input video stream (V0); (d) generating a streams manifest file, comprising at least: (i) a first pointer which points to a first storage address that stores the first generated video stream (V1), and also (ii) a second pointer which points to a second storage address that stores the second generated video stream (V2). The streams manifest file enables a video playback unit to dynamically transition, during video playback and in response to a user command, from (i) playback of the first generated video stream (V1) that is a downscaled version of the entire field-of-view the input video stream, to (ii) playback of the second video stream (V2) which tracks said object-of-interest within said partial field-of-view.

In some embodiments, step (c) comprises: performing a computer vision analysis of said input video stream (V0), and recognizing an object-of-interest that is visually depicted in said input video stream (V0), and tracking in-frame locations of said object-of-interest across multiple frames of said input video stream (V0).

In some embodiments, step (c) further comprises: cropping original non-downscaled frames of said input video stream (V0), into cropped frames that are composed to form the second video stream (V2); wherein each cropped frame contains therein said object-of-interest; wherein at least two cropped frames are cropped at different in-frame locations of said input video stream (V0).

In some embodiments, the method comprises: performing a computer vision analysis of said input video stream (V0), and recognizing at least a first object-of-interest and a second object-of-interest that are visually depicted in said input video stream (V0); applying an object tracking algorithm to track the in-frame location of the first object-of-interest across frames of said input video stream (V0), and generating a first set of metadata indicating the in-frame location of the first object-of-interest across frames of said input video stream (V0); applying said object tracking algorithm to track the in-frame location of the second object-of-interest across frames of said input video stream (V0), and generating a second set of metadata indicating the in-frame location of the second object-of-interest across frames of said input video stream (V0).

In some embodiments, the method comprises: based on said first set of metadata, generating from said input video stream (V0) a first cropped non-downscaled video stream, which tracks the first object-of-interest; based on said second set of metadata, generating from said input video stream (V0) a second cropped non-downscaled video stream, which tracks the second object-of-interest.

In some embodiments, the method comprises: inserting to said streams manifest file at least: (i) a first pointer to a first storage address that stores the first cropped non-downscaled video stream which tracks the first object-of-interest, and (ii) a second pointer to a second storage address that stores the second cropped non-downscaled video stream which tracks the second object-of-interest.

In some embodiments, the method comprises: in response to a first user-command, which indicates a request via an end-user device to perform a zoom-in operation on the first object-of-interest, providing to said end-user device the first cropped non-downscaled video stream which tracks the first object-of-interest; in response to a second user-command, which indicates a request via said end-user device to perform a zoom-in operation on the second object-of-interest, providing to said end-user device the second cropped non-downscaled video stream which tracks the second object-of-interest.

In some embodiments, the method comprises: segmenting said input video stream (V0) into a plurality of time-segments of equal length; (I) for each of said time-segments of said input video stream (V0), generating a corresponding video-segment that corresponds to a downscaled video-segment depicting a full field-of-view of said video input stream (V0), to form said first video stream (V1) which is a downscaled version of said input video stream (V0); and, (II) for each of said time-segments of said input video stream (V0), generating a corresponding video-segment that corresponds to a cropped non-downscaled video-segment depicting that visually tracks said first object-of-interest within said video input file (V0), to form said second video stream (V2) which is a cropped non-downscaled version of said input video stream (V0).

In some embodiments, the method comprises: tracking a plurality of objects-of-interest within said input video stream; generating a plurality of secondary video streams; wherein each one of the secondary video streams tracks a single object-of-interest that appears in the input video stream and that moves within the input video stream; wherein each one of the secondary video streams has an area, in pixels, that is smaller relative to the area in pixels of the input video stream.

In some embodiments, the input video stream is a 4K video stream or an 8K video stream; wherein the method comprises: tracking a plurality of objects-of-interest within said input video stream; generating a plurality of secondary video streams, wherein each one of the secondary video streams tracks a single object-of-interest that appears in the input video stream and that moves within the input video stream; wherein each one of the secondary video streams has an area, in pixels, of either 480p or 720p or 1080p.

Some embodiments may include a server apparatus, comprising: one or more hardware processors to execute code, operably associated with one or more memory units to store code; wherein the one or more hardware processors are configured to perform a method as described above.

In some embodiments, a method comprises: (a) receiving at a video playback device, a streams manifest file of a video; wherein the streams manifest file comprises at least: (i) a first pointer to a first storage address of a first video stream (V1) depicting a full field-of-view of a video scene, and (ii) a second pointer to a second storage address of a second video stream (V2) depicting a cropped of said video scene; wherein the first video stream and the second video stream have same video resolution measured in pixels; (b) playing the first video stream (V1) on said video playback device; (c) in response to a zoom-in command received at a particular time-point (T) during playback of the first video stream, transitioning from playing the first video stream (V1) on said video playback device to playing said second video stream (V2) on said video playback device from time-point T of said second video stream and onward.

In some embodiments, the method comprises: parsing said streams manifest file at the video playback device, and extracting from said streams manifest file at least: a set of metadata indicating an in-frame location of said object-of-interest in at least one frame of the first video stream (V1) which depicts the full field-of-view of said video scene.

In some embodiments, the method comprises: based on said set of metadata extracted from said streams manifest file, generating at the video playback device a visual marking which indicates to a user that said object-of-interest is zoomable; wherein the visual marking is generated and is displayed as an overlay element on top of the first video stream (V1) during playback of the first video stream.

In some embodiments, the method comprises: monitoring user engagement with said overlay element, via one or more input units of the video playback device; and upon user engagement with said overlay element at time-point T, transitioning from playing the first video stream (V1) on said video playback device to playing said second video stream (V2) on said video playback device from time-point T of said second video stream and onward.

In some embodiments, the method comprises: based on said set of metadata extracted from said streams manifest file, generating at the video playback device a textual indication which indicates to a user that describes said object-of-interest and that indicates to the user that said object-of-interest is zoomable.

In some embodiments, the method comprises: between step (b) and step (c), generating and displaying on said video playback device a smooth transition effect, that emulates a smooth transition from (i) playback of the first video stream (V1), to (playback of the second video stream (V2).

In some embodiments, the method comprises: receiving at said video playback device, said streams manifest file which points to said first video stream and to a plurality of secondary video streams; wherein each one of the secondary video streams tracks a single object-of-interest that appears in the first video stream and that moves within the first video stream; wherein each one of the secondary video streams has an area, in pixels, that is smaller relative to the area in pixels of the first video stream.

In some embodiments, the method comprises: receiving at said video playback device, said streams manifest file which points to said first video stream and to a plurality of secondary video streams; wherein the first video stream is a 4K video stream or an 8K video stream; wherein each one of the secondary video streams is either 480p or 720p or 1080p; wherein each one of the secondary video streams tracks a single object-of-interest that appears in the first video stream and that moves within the first video stream.

Some embodiments include a video playback device, comprising: a hardware processor to execute code, operably associated with a memory unit to store code; wherein the hardware processor is configured to perform a method as described above.

Some embodiments provide a system, device, and method for enabling high-quality content-aware zoom-in for videos. For example, an input video is received at high resolution, and is processed. A first video stream is generated, being a downscaled lower-resolution version of the input video. One or more additional video streams are generated; each one of them being a cropped high-resolution version of the input video, such that the cropped region tracks an object-of-interest that is visually depicted in the input video. A multiple-streams manifest is generated, pointing to the first, downscaled, video stream, and also pointing to the one or more other, cropped high-resolution video stream. An end-user device plays the video, and enables the end-user to perform a high-quality zoom-in on the object-of-interest, by transitioning from playback of the downscaled video stream to playback of the additional video stream that tracks that object-of-interest.

In some embodiments, in order to perform the computerized operations described above, the relevant system or devices may be equipped with suitable hardware components and/or software components; for example: a processor able to process data and/or execute code or machine-readable instructions (e.g., a central processing unit (CPU), a graphic processing unit (GPU), a digital signal processor (DSP), a processing core, an Integrated Circuit (IC), an Application-Specific IC (ASIC), one or more controllers, a logic unit, or the like); a memory unit able to store data for short term (e.g., Random Access Memory (RAM), volatile memory); a storage unit able to store data for long term (e.g., non-volatile memory, Flash memory, hard disk drive, solid state drive, optical drive); an input unit able to receive user's input (e.g., keyboard, keypad, mouse, touch-pad, touch-screen, trackball, microphone); an output unit able to generate or produce or provide output (e.g., screen, touch-screen, monitor, display unit, audio speakers); one or more transceivers or transmitters or receivers or communication units (e.g., Wi-Fi transceiver, cellular transceiver, Bluetooth transceiver, wireless communication transceiver, wired transceiver, Network Interface Card (NIC), modem); and other suitable components (e.g., a power source, an Operating System (OS), drivers, one or more applications or “apps” or software modules, or the like).

In accordance with embodiments of the present invention, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Although portions of the discussion herein relate, for demonstrative purposes, to wired links and/or wired communications, some embodiments are not limited in this regard, but rather, may utilize wired communication and/or wireless communication; may include one or more wired and/or wireless links; may utilize one or more components of wired communication and/or wireless communication; and/or may utilize one or more methods or protocols or standards of wireless communication.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), BASIC, Visual BASIC, Matlab, Pascal, HTML, HTML5, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a legend list or a database of possible values or ranges; a comparison or matching or searching process which searches for matches and/or identical results and/or similar results among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), or the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may thus comprise any possible or suitable combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments of the present invention have been illustrated and described herein, various modifications, substitutions, changes, and equivalents may occur to those skilled in the art. Accordingly, the claims are intended to cover all such modifications, substitutions, changes, and equivalents.

What is claimed is:

1. A method comprising:
(a) receiving an input video file comprising at least an input video stream (V0) having an input video resolution (R0) comprising an input width in pixels (W0) and an input length in pixels (L0);
(b) generating from said input video stream (V0) a first generated video stream (V1), which is a downscaled and non-cropped version of an entire field-of-view of said input video stream (V0), wherein the first generated video stream (V1) has a first video resolution (R1) that is smaller than the input video resolution (R0), wherein the first video resolution (R1) has a width in pixels (W1) that is smaller than the input width in pixels (W0), wherein the first video resolution (R1) has a length in pixels (L1) that is smaller than the input length in pixels (L0);
(c) generating from said input video stream (V0) a second generated video stream (V2), which is a non-downscaled cropped region of only a partial field-of-view of said input video stream (V0), wherein the second generated video stream (V2) has said first video resolution (R1) that is smaller than the input video resolution (R0); wherein the second video stream (V2) tracks an object-of-interest that is visually depicted in said input video stream (V0);
(d) generating a streams manifest file, comprising at least: (i) a first pointer which points to a first storage address that stores the first generated video stream (V1), and also (ii) a second pointer which points to a second storage address that stores the second generated video stream (V2);
wherein said streams manifest file enables a video playback unit to dynamically transition, during video playback and in response to a user command, from (i) playback of the first generated video stream (V1) that is a downscaled version of the entire field-of-view the input video stream, to (ii) playback of the second video stream (V2) which tracks said object-of-interest within said partial field-of-view.

2. The method of claim 1,
wherein step (c) comprises:
performing a computer vision analysis of said input video stream (V0), and recognizing an object-of-interest that is visually depicted in said input video stream (V0), and tracking in-frame locations of said object-of-interest across multiple frames of said input video stream (V0).

3. The method of claim 2,
wherein step (c) further comprises:
cropping original non-downscaled frames of said input video stream (V0), into cropped frames that are composed to form the second video stream (V2);
wherein each cropped frame contains therein said object-of-interest;
wherein at least two cropped frames are cropped at different in-frame locations of said input video stream (V0).

4. The method of claim 1, comprising:
performing a computer vision analysis of said input video stream (V0), and recognizing at least a first object-of-interest and a second object-of-interest that are visually depicted in said input video stream (V0);
applying an object tracking algorithm to track the in-frame location of the first object-of-interest across frames of said input video stream (V0), and generating a first set of metadata indicating the in-frame location of the first object-of-interest across frames of said input video stream (V0);
applying said object tracking algorithm to track the in-frame location of the second object-of-interest across frames of said input video stream (V0), and generating a second set of metadata indicating the in-frame location of the second object-of-interest across frames of said input video stream (V0).

5. The method of claim 4, comprising:
based on said first set of metadata, generating from said input video stream (V0) a first cropped non-downscaled video stream, which tracks the first object-of-interest;
based on said second set of metadata, generating from said input video stream (V0) a second cropped non-downscaled video stream, which tracks the second object-of-interest.

6. The method of claim 5, comprising:
inserting to said streams manifest file at least: (i) a first pointer to a first storage address that stores the first cropped non-downscaled video stream which tracks the first object-of-interest, and (ii) a second pointer to a second storage address that stores the second cropped non-downscaled video stream which tracks the second object-of-interest.

7. The method of claim 6, comprising:
in response to a first user-command, which indicates a request via an end-user device to perform a zoom-in operation on the first object-of-interest, providing to said end-user device the first cropped non-downscaled video stream which tracks the first object-of-interest;
in response to a second user-command, which indicates a request via said end-user device to perform a zoom-in operation on the second object-of-interest, providing to said end-user device the second cropped non-downscaled video stream which tracks the second object-of-interest.

8. The method of claim 1, comprising:
segmenting said input video stream (V0) into a plurality of time-segments of equal length;
(I) for each of said time-segments of said input video stream (V0),
generating a corresponding video-segment that corresponds to a downscaled video-segment depicting a full field-of-view of said video input stream (V0), to form said first video stream (V1) which is a downscaled version of said input video stream (V0);
(II) for each of said time-segments of said input video stream (V0),
generating a corresponding video-segment that corresponds to a cropped non-downscaled video-segment depicting that visually tracks said first object-of-interest within said video input file (V0), to form said second video stream (V2) which is a cropped non-downscaled version of said input video stream (V0).

9. The method of claim 1, wherein the method comprises:
tracking a plurality of objects-of-interest within said input video stream;
generating a plurality of secondary video streams,
wherein each one of the secondary video streams tracks a single object-of-interest that appears in the input video stream and that moves within the input video stream;
wherein each one of the secondary video streams has an area, in pixels, that is smaller relative to the area in pixels of the input video stream.

10. The method of claim 1,
wherein the input video stream is a 4K video stream or an 8K video stream;
wherein the method comprises:
tracking a plurality of objects-of-interest within said input video stream;
generating a plurality of secondary video streams,
wherein each one of the secondary video streams tracks a single object-of-interest that appears in the input video stream and that moves within the input video stream;
wherein each one of the secondary video streams has an area, in pixels, of either 480p or 720p or 1080p.

11. A method comprising:
(a) receiving at a video playback device, a streams manifest file of a video; wherein the streams manifest file comprises at least:
(i) a first pointer to a first storage address of a first video stream (V1) depicting a full field-of-view of a video scene, and
(ii) a second pointer to a second storage address of a second video stream (V2) depicting a cropped of said video scene;
wherein the first video stream and the second video stream have same video resolution measured in pixels;
(b) playing the first video stream (V1) on said video playback device;
(c) in response to a zoom-in command received at a particular time-point (T) during playback of the first video stream, transitioning from playing the first video stream (V1) on said video playback device to playing said second video stream (V2) on said video playback device from time-point T of said second video stream and onward.

12. The method of claim 11, comprising:
parsing said streams manifest file at the video playback device,
and extracting from said streams manifest file at least: a set of metadata indicating an in-frame location of said object-of-interest in at least one frame of the first video stream (V1) which depicts the full field-of-view of said video scene.

13. The method of claim 11, comprising:
based on said set of metadata extracted from said streams manifest file,
generating at the video playback device a visual marking which indicates to a user that said object-of-interest is zoomable; wherein the visual marking is generated and is displayed as an overlay element on top of the first video stream (V1) during playback of the first video stream.

14. The method of claim 11, comprising:
monitoring user engagement with said overlay element, via one or more input units of the video playback device; and upon user engagement with said overlay element at time-point T, transitioning from playing the first video stream (V1) on said video playback device to playing said second video stream (V2) on said video playback device from time-point T of said second video stream and onward.

15. The method of claim 11, comprising:
based on said set of metadata extracted from said streams manifest file,
generating at the video playback device a textual indication which indicates to a user that describes said object-of-interest and that indicates to the user that said object-of-interest is zoomable.

16. The method of claim 11, comprising:
between step (b) and step (c), generating and displaying on said video playback device a smooth transition effect, that emulates a smooth transition from (i) playback of the first video stream (V1), to (playback of the second video stream (V2).

17. The method of claim 11,
wherein the method comprises:
receiving at said video playback device, said streams manifest file which points to said first video stream and to a plurality of secondary video streams,
wherein each one of the secondary video streams tracks a single object-of-interest that appears in the first video stream and that moves within the first video stream;
wherein each one of the secondary video streams has an area, in pixels, that is smaller relative to the area in pixels of the first video stream.

18. The method of claim 11,
wherein the method comprises:
receiving at said video playback device, said streams manifest file which points to said first video stream and to a plurality of secondary video streams,
wherein the first video stream is a 4K video stream or an 8K video stream,
wherein each one of the secondary video streams is either 480p or 720p or 1080p,
wherein each one of the secondary video streams tracks a single object-of-interest that appears in the first video stream and that moves within the first video stream.

19. A server apparatus, comprising:
one or more hardware processors to execute code,
operably associated with one or more memory units to store code;
wherein the one or more hardware processors are configured to perform:
(a) receiving an input video file comprising at least an input video stream (V0) having an input video resolution (R0) comprising an input width in pixels (W0) and an input length in pixels (L0);
(b) generating from said input video stream (V0) a first generated video stream (V1), which is a downscaled and non-cropped version of an entire field-of-view of said input video stream (V0), wherein the first generated video stream (V1) has a first video resolution (R1) that is smaller than the input video resolution (R0), wherein the first video resolution (R1) has a width in pixels (W1) that is smaller than the input width in pixels (W0), wherein the first video resolution (R1) has a length in pixels (L1) that is smaller than the input length in pixels (L0);
(c) generating from said input video stream (V0) a second generated video stream (V2), which is a non-downscaled cropped region of only a partial field-of-view of said input video stream (V0), wherein the second generated video stream (V2) has said first video resolution (R1) that is smaller than the input video resolution (R0); wherein the second video stream (V2) tracks an object-of-interest that is visually depicted in said input video stream (V0);
(d) generating a streams manifest file, comprising at least: (i) a first pointer which points to a first storage address that stores the first generated video stream (V1), and also (ii) a second pointer which points to a second storage address that stores the second generated video stream (V2);
wherein said streams manifest file enables a video playback unit to dynamically transition, during video playback and in response to a user command, from (i) playback of the first generated video stream (V1) that is a downscaled version of the entire field-of-view the input video stream, to (ii) playback of the second video stream (V2) which tracks said object-of-interest within said partial field-of-view.

20. A video playback device, comprising:
a hardware processor to execute code,
operably associated with a memory unit to store code;
wherein the hardware processor is configured to perform:
(a) receiving at the video playback device, a streams manifest file of a video; wherein the streams manifest file comprises at least:
(i) a first pointer to a first storage address of a first video stream (V1) depicting a full field-of-view of a video scene, and
(ii) a second pointer to a second storage address of a second video stream (V2) depicting a cropped of said video scene;
wherein the first video stream and the second video stream have same video resolution measured in pixels;
(b) playing the first video stream (V1) on said video playback device;
(c) in response to a zoom-in command received at a particular time-point (T) during playback of the first video stream, transitioning from playing the first video stream (V1) on said video playback device to playing said second video stream (V2) on said video playback device from time-point T of said second video stream and onward.
